(19) United States
(12) Patent Application Publication
(10) Pub. No.: US 2010/0176291 A1
(43) Pub. Date: Jul. 15, 2010

(54) MASS SPECTROMETER

(75) Inventors: James Hager, Mississauga (CA); Darin Latimer, Aurora (CA)

Correspondence Address: ROPES & GRAY LLP, PATENT DOCKETING 39/41, ONE INTERNATIONAL PLACE, BOSTON, MA, 02110-2624, US

(73) Assignee: MDS Analytical Technologies, Concord (CA)

(21) Appl. No.: 12/684,703

(22) Filed: Jan. 8, 2010

Related U.S. Application Data
(60) Provisional application No. 61/204,726, filed on Jan. 9, 2009.

(51) Int. Cl. H01J 49/42; H01J 49/06

(52) U.S. Cl. 250/283; 250/292; 250/282

(57) ABSTRACT

A mass analyzer system includes an ion inlet that receives a flow of ions, a multi-mode ion controller that controls some or all of the ions, and a multi-mode mass analyzer, in communication with the ion controller, that performs at least one of analyzing and controlling some or all of the ions. The system also includes a detector, in communication with the multi-mode mass analyzer, that detects some or all of the ions and a processor that controls the operation of at least one of the multi-mode ion controller and the multimode mass analyzer.

### CROSS REFERENCE TO RELATED APPLICATIONS

This application claims the benefit of U.S. Provisional Application Ser. No. 61/204,726, filed Jan. 9, 2009, the entire contents of which are incorporated herein by reference.

### FIELD

The application relates to mass analyzer systems including mass analyzer systems employing multi-mode analyzing components.

### Introduction

Mass spectrometry is a known instrumental technique in which compounds to be analyzed are first converted to ions (or, if already in the form of ions, are separated from the surrounding liquid), and then separated or filtered according to their mass-to-charge ratio (m/z), before being detected and counted with an ion or current detector. The output of such analysis is usually a mass spectrum in which the signal at each mass-to-charge ratio (m/z) is proportional to the concentration of each species which has that m/z.

Tandem mass spectrometry is a powerful analytical technique which is used for structural analysis of chemical species, as well as for the specific detection of known targeted compounds in the presence of many other compounds, or in samples which contain a wide variety of endogenous species which otherwise would obscure the presence of the compound of interest. Tandem mass spectrometry fragments ions of selected m/z at a controlled energy, usually by collisions with a low density gas (a process called collision induced dissociation, or CID). By selecting a narrow m/z range (e.g. 1 amu wide) to be transmitted into the collision cell, and recording the mass spectrum of fragment ions by means of a second mass spectrometer placed after the collision cell, a tandem mass spectrum or mass fingerprint of the precursor ion is produced. This technique of fragmentation of a selected ion mass is called MS/MS.

A conventional tandem mass spectrometer, the triple quadrupole, is illustrated in FIG. 1. The mass spectrometer 100 has an ion source 102, which generates ions that are directed through a small orifice 104 into a vacuum chamber 106. The ions then pass through an aperture 108 into chamber 110 that includes an ion guide Q0, which has a quadrupole rod set 112 powered by an RF power supply 114. The ions are cooled and focused in ion guide Q0, then passed into a resolving chamber 116 including two short RF-only rods 118 and resolving quadrupole Q1, which includes a quadrupole rod set 120 that can be powered by an RF/DC supply 122. Resolving quadrupole Q1 acts as a mass analyzer, selecting parent ions of interest to be fragmented into daughter ions in a low pressure collision cell Q2 within chamber 124, which has a collision gas supply 126. In collision cell Q2, the daughter ions are directed by quadrupole rod set 128 into a chamber 130, having mass filter Q3, which includes a quadrupole rod set 132 that is powered by an RF/DC and auxiliary AC supply 134. The mass filter Q3 passes the daughter ions of interest through an exit lens 136 to a detector 138. In a Product Scan Mode, Q1 is tuned to the precursor mass-to-charge (m/z) value of interest, and Q3 is scanned to record an MS/MS spectrum. In a Precursor Scan Mode, Q1 is scanned while Q3 is fixed at a product ion of interest. In a Neutral Loss Scan mode, both quadrupoles are scanned with a fixed mass difference between them.

Another known and different type of tandem mass spectrometer is a quadrupole ion trap, which can be of either a 3-dimensional or linear type. In these devices, all mass analysis is performed on ions which are trapped within a fixed volume (within quadrupole electrodes inside a vacuum system). Ions are trapped within a volume using either a radio-frequency quadrupole field or a combination of radio-frequency and direct current fields. By changing the fields applied to the trapping electrodes, ions can be isolated (to remove all but a selected m/z), fragmented (by collisions with a low density gas which fill the device), and then scanned to record a mass spectrum. This process can be repeated many times to obtain information from multiple stages of mass spectrometry. Because all of the events occur in the same region of space, but sequentially in time (first filling the trap with ions, then isolating the precursor ion, then fragmenting the precursor ions, then recording the mass spectrum of the products), the ion trap is sometimes referred to as “tandem in time” as opposed to a triple quadrupole which is “tandem in space”.

In other types of tandem mass spectrometers, such as triple quadrupoles and QqTOF instruments, which perform MS/MS by means of two mass spectrometers which are separated in space, higher orders of MS can only normally be done by adding another collision cell and another mass spectrometer. However, such configurations are complex and expensive, and are not commonly available.

Certain current mass analyzer systems include systems that are relatively large and cumbersome and, therefore, not particularly portable. Also, current mass analyzers often require multiple components that increase the analyzer's form factor and power consumption requirements. Accordingly, there is a need to reduce the size and power consumption requirements of existing mass analyzers along with making such devices more portable.

### SUMMARY

The application, in various embodiments, addresses the deficiencies of current mass analyzer systems by providing a more compact and portable mass analyzer system using multi-mode components and a controller to efficiently control the operation of the multi-mode components.

In one aspect, a mass analyzer system includes an ion inlet that receives a flow of ions; a multi-mode ion controller that controls some or all of the ions; a multi-mode mass analyzer, in communication with the ion controller, that performs at least one of analyzing and controlling some or all of the ions; and a detector, in communication with the multi-mode mass analyzer, for detecting some or all of the ions. A system controller, which can include a microcontroller, can control the operation of at least one of the multi-mode ion controller and the multi-mode mass analyzer.

The multi-mode ion controller can function in a plurality of modes, including an ion trap mode, a collision cell mode, and an ion guide mode. The multi-mode mass analyzer can function in a plurality of modes including a mass selector mode and an ion controller mode. The mass selector mode enables the mass analyzer to function as at least one of a linear ion trap or a quadrupole mass spectrometer. The ion controller mode includes an ion trap mode, a collision cell mode, and an ion guide mode.

The system controller can control the direction of flow of the ions by controlling the operation of at least one of the multi-mode ion controller and the multi-mode mass analyzer. The system controller can set a first mode of operation of at least one of the multi-mode ion controller and the multi-mode mass analyzer at a first instance. The system controller can also set a second mode of operation of at least one of the multi-mode ion controller and the multi-mode mass analyzer at a second instance.

In one process, the system controller controls the operation of the multi-mode ion controller and the multimode mass analyzer in the following manner. Ions can be passed through the multi-mode ion controller, which includes at least one of an RF multi-pole and an RF ring guide. The multi-mode ion controller can operate in an ion guide mode and can pass ions into the multi-mode mass analyzer, which can operate in a mass selector mode to select a first portion of ions, including precursor ions. Some or all of the first portion of ions may be passed to the detector. Then, the first portion of ions can be passed to the multi-mode ion controller, which can operate in a collision cell mode to fragment the first portion of ions into a second portion of ions, including daughter ions. The second portion of ions can be passed to the multi-mode mass analyzer, operating in a mass selector mode, to select a third portion of ions, which can then passed to the detector for detection.

In another aspect, a mass analyzer system includes an ion inlet for receiving a flow of ions; a multi-mode ion controller for controlling some or all of the ions; a multi-mode mass analyzer, in communication with the ion controller, for performing at least one of analyzing and controlling some or all of the ions; an ion trap, in communication with the multi-mode mass analyzer, for trapping some or all of the ions; and a detector, in communication with the ion trap, for detecting some or all of the ions. A system controller, which can include a microcontroller, can control the operation of at least one of the multi-mode ion controller and the multimode mass analyzer.

The multi-mode ion controller can function in a plurality of modes, including an ion trap mode, a collision cell mode, and an ion guide mode. The multi-mode mass analyzer can function in a plurality of modes including a mass selector mode and an ion controller mode. The mass selector mode can enable the mass analyzer to function as at least one of a linear ion trap and a quadrupole mass spectrometer. The ion controller mode can include an ion trap mode, a collision cell mode, and an ion guide mode.

The system controller can control the direction of flow of the ions by controlling the operation of at least one of the multi-mode ion controller and the multi-mode mass analyzer. The system controller can set a first mode of operation of at least one of the multi-mode ion controller and the multi-mode mass analyzer at a first instance. The system controller can also set a second mode of operation of at least one of the multi-mode ion controller and the multi-mode mass analyzer at a second instance.

In one process, the system controller controls the operation of the multi-mode ion controller and the multi-mode mass analyzer in the following manner. Ions are passed through the multi-mode ion controller, which includes at least one of an RF multi-pole and an RF ring guide. The multi-mode ion controller operates in an ion guide mode and passes the ions into the multi-mode mass analyzer, which operates in a linear ion trap mode with ion selection capability to select a first portion of ions, including precursor ions. Some or all of the first portion of ions may be passed to the detector. The first portion of ions is then passed into the multi-mode ion controller. The multi-mode ion controller operates in a collision cell mode to fragment the first portion of ions into a second portion of ions, including daughter ions. The second portion of ions is passed to the multi-mode mass analyzer, operating in a mass selector mode, to select a third portion of ions, which is then passed to the detector for detection.

In another process, the system controller can control the operation of the multi-mode ion controller and the multi-mode mass analyzer to in the following manner. Ions are passed through the multi-mode ion controller, which includes at least one of an RF multi-pole and an RF ring guide. The multi-mode ion controller operates in an ion guide mode and passes the ions through the multi-mode mass analyzer, which operates in a mass analyzer mode and passes a preselected range of m/z ions into the ion trap. The ions are then passed through the multi-mode mass analyzer, operating in an ion guide mode, into the multi-mode ion controller. The multi-mode ion controller operates in a collision cell mode to fragment the ions into a first portion of ions. The first portion of ions is passed to the multi-mode mass analyzer, operating in a mass selector mode, to select a second portion of ions, which is then passed to the detector for detection.

While various processes may be described herein, one of ordinary skill can appreciate that the multi-mode elements and control provided by a controller can enable various mass analyzer systems as described herein to operation in any number of sequences and operating modes to affect any number of analyses.

These and other features of the applicant's teachings are set forth herein.

### DRAWINGS

The skilled person in the art will understand that the drawings, described below, are for illustration purposes only. The drawings are not intended to limit the scope of the applicant's teachings in any way.

FIG. 1 is a schematic view of a conventional mass spectrometer;

FIG. 2A is a schematic view of a mass analyzer system according to an illustrative embodiment of the invention.

FIG. 2B is a flow diagram of a process for analyzing ions using the system of FIG. 2A according to an illustrative embodiment of the invention.

FIG. 3A is a schematic view of another mass analyzer system according to an illustrative embodiment of the invention.

FIG. 3B is a flow diagram of a process for analyzing ions using the system of FIG. 3A according to an illustrative embodiment of the invention.

FIG. 3C is a flow diagram of another process for analyzing ions using the system of FIG. 3A according to an illustrative embodiment of the invention.

FIG. 4A is a graph comparing space charge effects of various linear ion trap filling approaches according to an illustrative embodiment of the invention.

FIG. 4B is a graph comparing space charge effects of linear ion trap filling approaches according to an illustrative embodiment of the invention.

FIG. 5A is a graph comparing transfer times out of a multi-mode ion controller using various ion transfer approaches according to an illustrative embodiment of the invention.

FIG. 5B is a graph showing Q0-to-Q2 transfer time according to an illustrative embodiment of the invention.

FIG. 6A is a graph comparing transfer times back to Q0 according to illustrative embodiments of the invention.

FIG. 6B is a graph showing the Q2-to-Q0 transfer time according to an illustrative embodiment of the invention.

FIG. 7A is a radial schematic view of the front end of an ion controller with a linear particle accelerator (LINAC) according to an illustrative embodiment of the invention.

FIG. 7B is a radial schematic view of the back end of an ion controller with a linear particle accelerator (LINAC) according to an illustrative embodiment of the invention.

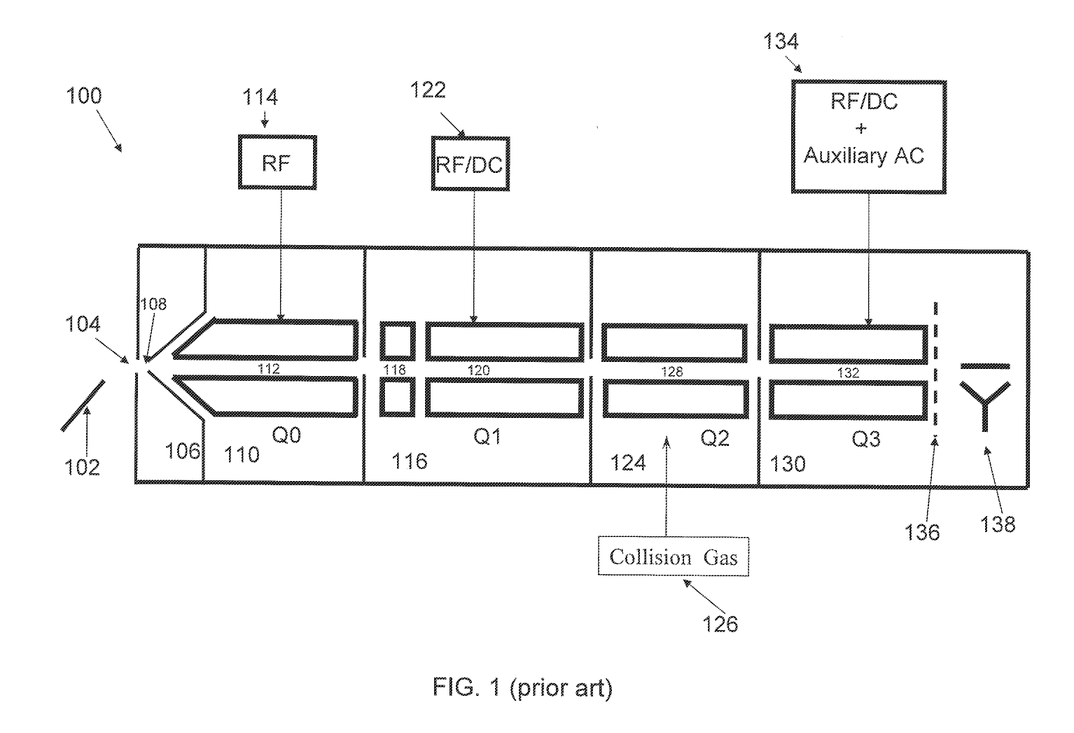

### DESCRIPTION OF VARIOUS EMBODIMENTS

Aspects of the applicant's teachings may be further understood in light of the following examples, which should not be construed as limiting the scope of the applicant's teachings in any way.

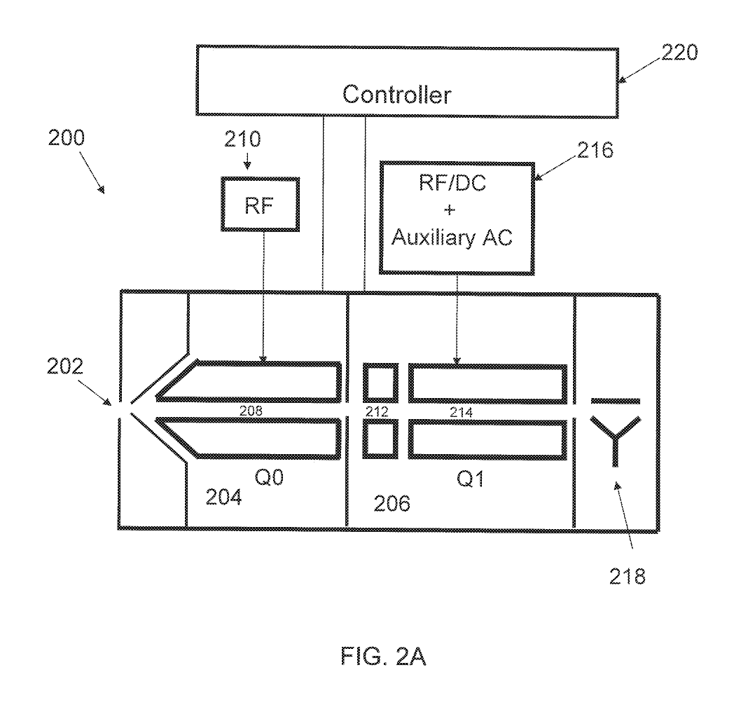

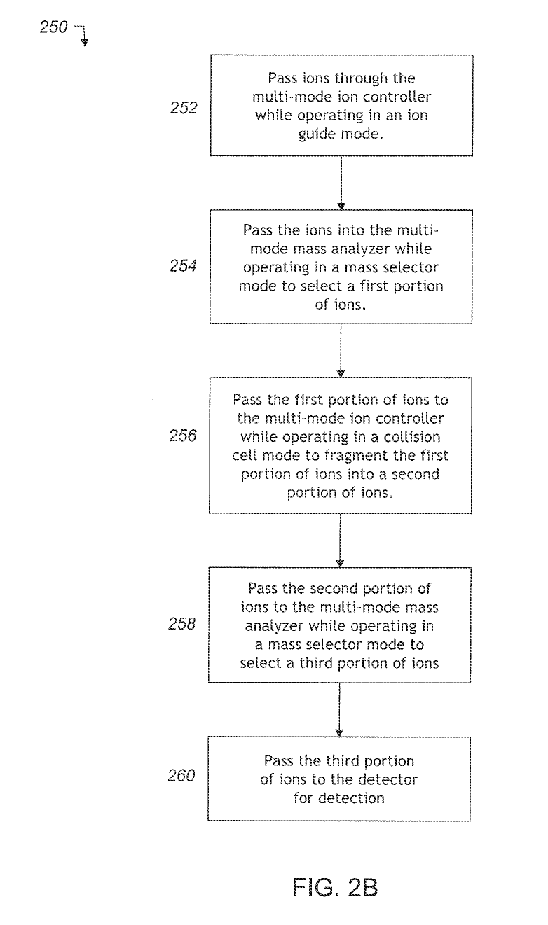

FIG. 2A is a schematic view of mass analyzer system 200 according to an illustrative embodiment of the invention. The mass analyzer system 200 includes an ion inlet 202, a chamber 204 including a multi-mode ion controller Q0, a chamber 206 including a multi-mode mass analyzer Q1, and a detector 218. The system 200 can also include a radio frequency (RF) power supply 210 that supplies an RF signal to a quadrupole rod set 208 of the multi-mode ion controller Q0. The system 200 can further include an RF/DC auxiliary alternating current (AC) power supply that supplies RF and/or DC signals, and/or an auxiliary AC signal to a quadrupole rod set 214 of the multi-mode mass analyzer Q1. The chamber 206 can include a shortened quadrupole rod set 212, which can act as Brubaker lenses, adjacent to the multi-mode mass analyzer Q1. The system 200 can also include a controller 220. The controller 220 can include a processor that enables the control of the multi-mode ion controller Q0 and/or multi-mode mass analyzer Q1. The processor can include and/or interface with a memory having software and/or hardware code configured to enable the control of the system 200.

The multi-mode ion controller Q0 can be operable to function in multiple modes of operation. The modes of operation can include, without limitation, an ion guide mode, a collision cell mode, and an ion trap mode. In an ion guide mode, Q0 can function to cool and focus a wide mass range of ions. That is, no ion selection is performed when Q0 operates in an ion guide mode.

In certain embodiments when Q0 functions in a collision cell mode, inert gas (for example, helium, nitrogen, argon, or the like) can be pumped into chamber 204 to initiate collision induced dissociation (CID) of ions. Ions in Q0, such as parent ions, can collide with gas molecules and break into fragments known as daughter ions. In certain embodiments when Q0 functions in an ion trap mode, an RF power supply can be used to create an electric field within the quadrupole rod set 208. By changing the amplitude and waveform of the applied field, ions of a selected m/z can be trapped within the quadrupole rod set 208.

The multi-mode mass analyzer Q1 can be operable to function in multiple modes of operation. The modes of operation can include a mass selector mode and/or an ion guide mode. The mass selector mode can enable the mass analyzer Q1 to function as a linear ion trap or a quadrupole mass spectrometer.

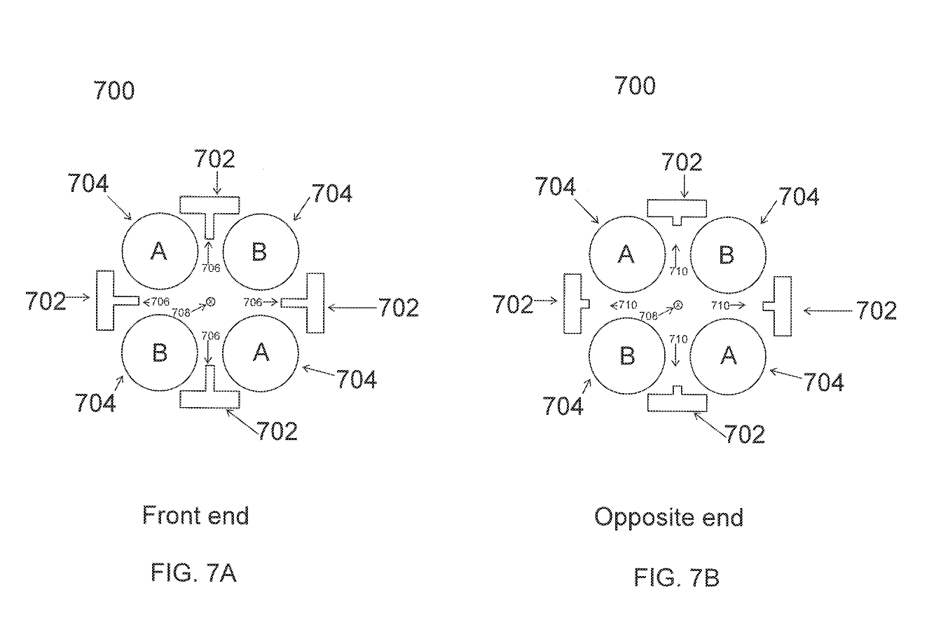

In some embodiments, the pressure within the chamber 204 is about 8×10⁻³ Torr, while the pressure within the chamber 206 is in the range of about 3×10⁻⁵ Torr to 5×10⁻⁵ Torr. In certain embodiments, Q0 and/or Q1 include one or more auxiliary electrodes such as a linear particle accelerator (LINAC) to speed up the transfer of ions between chambers, as illustrated in FIG. 7.

In operation, the system 200 can analyze sample ions by receiving ions at the inlet 202 and detecting a portion of the ions, portion of daughter ions, and/or portion of other related ions at the detector 218. Generally, the system 200 can perform a single MS survey scan where Q1 is operated in ion trap mode at one instance and then in mass selector mode in another instance. Multiple reaction monitoring (MRM) can be performed by trapping ions in Q1 with some degree of mass selection, then transferring the ions back into Q0 for collision induced dissociation (CID), and transferring the fragmented ions back through Q1, operating as a mass selector, to select fragmented ions, which are then transferred to the detector 218.

FIG. 2B is a flow diagram of a process 250 for analyzing ions using the system 200 of FIG. 2A according to an illustrative embodiment of the invention. First, the system 200 receives ions via the inlet 202 and passes ions through the multi-mode ion controller Q0, operating in an ion guide mode (Step 252). In certain embodiments, the controller 220 controls and/or sets the operating mode of the multi-mode ion controller Q0 to the ion guide mode. Then, the system 200 passes the ions into the multi-mode mass analyzer Q1, operating as a linear ion trap with mass selection, to select a first portion of ions (Step 254). Q1 passes the first portion of ions back to the multi-mode ion controller Q0, operating in a collision cell mode, to fragment the first portion of ions into a second portion of ions (Step 256). The second portion of ions are passed to the multi-mode mass analyzer Q1, operating in a mass selector mode, to select a third portion of ions (Step 258). The system 200 then passes the third portion of ions to the detector 218 for detection (Step 260).

In certain embodiments when Q1 functions in a mass selector mode, an applied voltage to the quadrupole rod set 214 can be used to transfer and select ions. An applied RF voltage can transfer ions of a wide mass range uniformly along the quadrupole rod set 214. An applied DC voltage can affect the trajectories of ions of different masses in different ways. The trajectories of heavier ions can be affected to a lesser extent than the trajectories of lighter ions. By varying the DC voltage in some embodiments, ions of a selected mass range can be allowed to pass through the chamber 206 while ions outside of the selected mass range collide with the quadrupole rod set 214 and are neutralized.

Analyzing ions using the system 200 and process 250 illustrated in FIGS. 2A and 2B can have several advantages. First, the design includes a single quadrupole element with simplified electronics, so the device has a smaller form factor and/or foot print, saving space and power consumption and, thus, making the system 200 more portable. Furthermore, the system 200 requires a lower cost vacuum system for pumping ions between chambers because there is no high-pressure collision cell in the high vacuum chamber. The collision cell functionality has been assumed by the multi-mode controller.

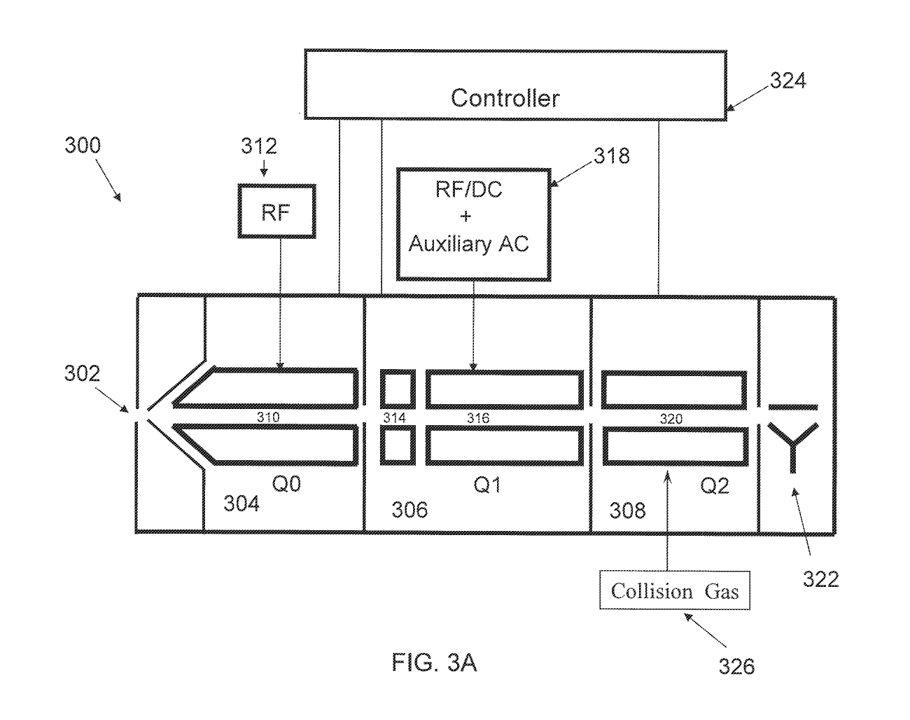

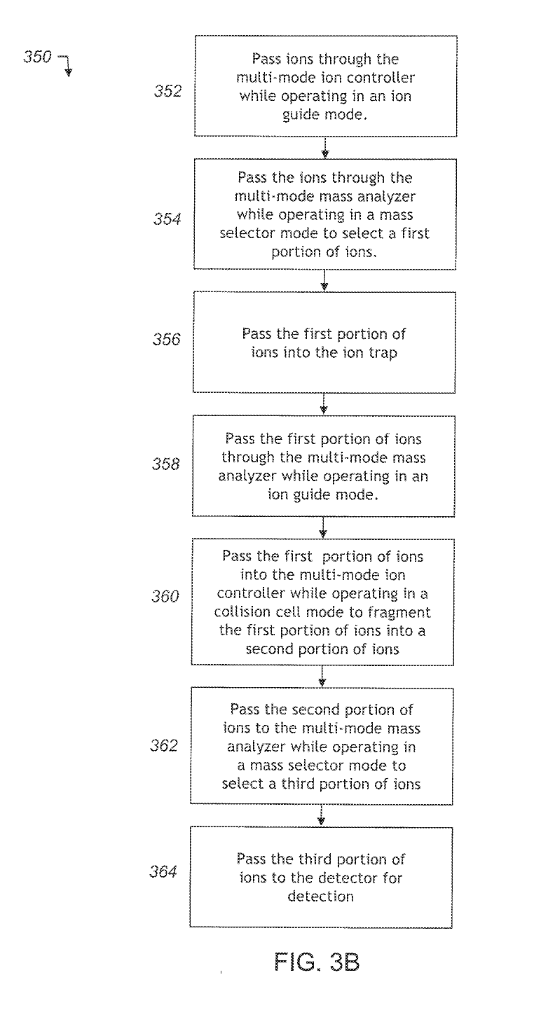

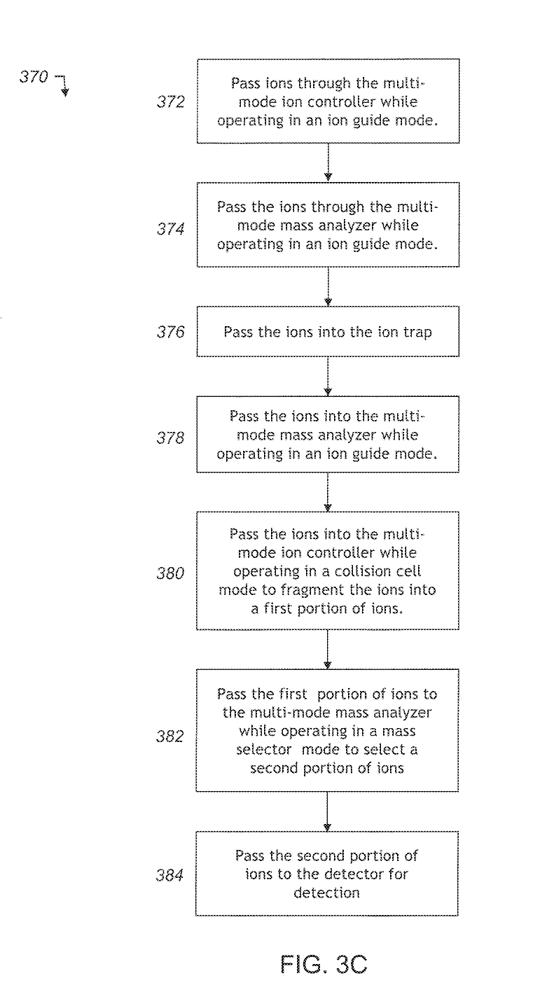

FIG. 3A is a schematic view of another mass analyzer system 300 according to an illustrative embodiment of the invention. The mass analyzer system 300 includes an ion inlet 302, a chamber 304 including a multi-mode ion controller Q0, a chamber 306 including a multi-mode mass analyzer Q1, a chamber 308 including an ion trap Q2, and a detector 322. The multi-mode ion controller Q0 can be operable to function in multiple modes of operation, which can include, without limitation, an ion guide mode, a collision cell mode, and an ion trap mode. The multi-mode mass analyzer Q1 can be operable to function in multiple modes of operation, which can include, without limitation, a mass selector mode and/or an ion guide mode. The system 300 can also include an RF power supply 312 that supplies an RF signal to a quadrupole rod set 310 of the multi-mode ion controller Q0. The system 300 can also include an RF/DC auxiliary AC power supply that supplies RF and/or DC signals, and/or an auxiliary AC signal to a quadrupole rod set 316 of the multi-mode mass analyzer Q1. The chamber 306 can include a shortened quadrupole rod set 314 adjacent to the multi-mode mass analyzer Q1. The chamber 308 can also include a quadrupole rod set 320 of the ion trap Q2. In various aspects, a collision gas supply 326 can be provided to Q2 to enhance precursor ion trapping efficiency in Q2. The system 300 can further include a controller 324. The controller 324 can include a processor that enables the control of the multi-mode ion controller Q0, the multi-mode mass analyzer Q1, and/or the ion trap Q2.

FIG. 3B is a flow diagram of a process 350 for analyzing ions using the system 300 of FIG. 3A according to an illustrative embodiment of the invention. First, the system 300 receives ions via the inlet 302 and passes ions through the multi-mode ion controller Q0, operating in an ion guide mode (Step 352). In certain embodiments, the controller 324 controls and/or sets the operating mode of the multi-mode ion controller Q0 to the ion guide mode. Then, the system 300 passes the ions into the multi-mode mass analyzer Q1, operating in a mass selector mode, to select a first portion of ions (Step 354). Q1 passes the first portion of ions into the ion trap Q2 (Step 356). The system 300 then passes the first portion of ions through the multi-mode mass analyzer Q1, operating in an ion guide mode (Step 358). Q1 passes the first portion of ions to the multi-mode ion controller Q0, operating in a collision cell mode, to fragment the first portion of ions into a second portion of ions (Step 360). The second portion of ions are passed to the multi-mode mass analyzer Q1, operating in a mass selector mode, to select a third portion of ions (Step 362). The system 300 then passes the third portion of ions to the detector 322 for detection (Step 364).

FIG. 3C is a flow diagram of another process 370 for analyzing ions using the system 300 of FIG. 3A according to an illustrative embodiment of the invention. First, the system 300 receives ions via the inlet 302 and passes ions through the multi-mode ion controller Q0, operating in an ion guide mode (Step 372). In certain embodiments, the controller 324 controls and/or sets the operating mode of the multi-mode ion controller Q0 to the ion guide mode. Then, the system 300 passes the ions into the multi-mode mass analyzer Q1, operating in an ion guide mode (Step 374). Q1 passes the ions into the ion trap Q2 (Step 376). The system 300 then passes the ions through the multi-mode mass analyzer Q1, operating in an ion guide mode (Step 378). Q1 passes the ions to the multi-mode ion controller Q0, operating in a collision cell mode, to fragment the ions into a first portion of ions (Step 380). The first portion of ions are passed to the multi-mode mass analyzer Q1, operating in a mass selector mode, to select a second portion of ions (Step 382). The system 300 then passes the second portion of ions to the detector 322 for detection (Step 384).

Analyzing ions using the system 300 and processes 350 and 370 illustrated in FIGS. 3A, 3B, and 3C has several advantages. In some embodiments, the system uses a quadrupole-linear ion trap approach to processing, so ions are selected by a resolving analyzer (e.g. Q1), and collected in a separate element (e.g. Q2) before being transferred to a collision cell (e.g. Q0) for fragmentation. This approach provides good isolation widths and reduces space charge effects. In addition, the need for cooling time in Q2 can be eliminated, so the cycle time for analysis is faster. Furthermore, the processes 350 and 370 require a lower cost vacuum system for pumping ions between chambers 304, 306, and 308, resulting in a lower cost product.

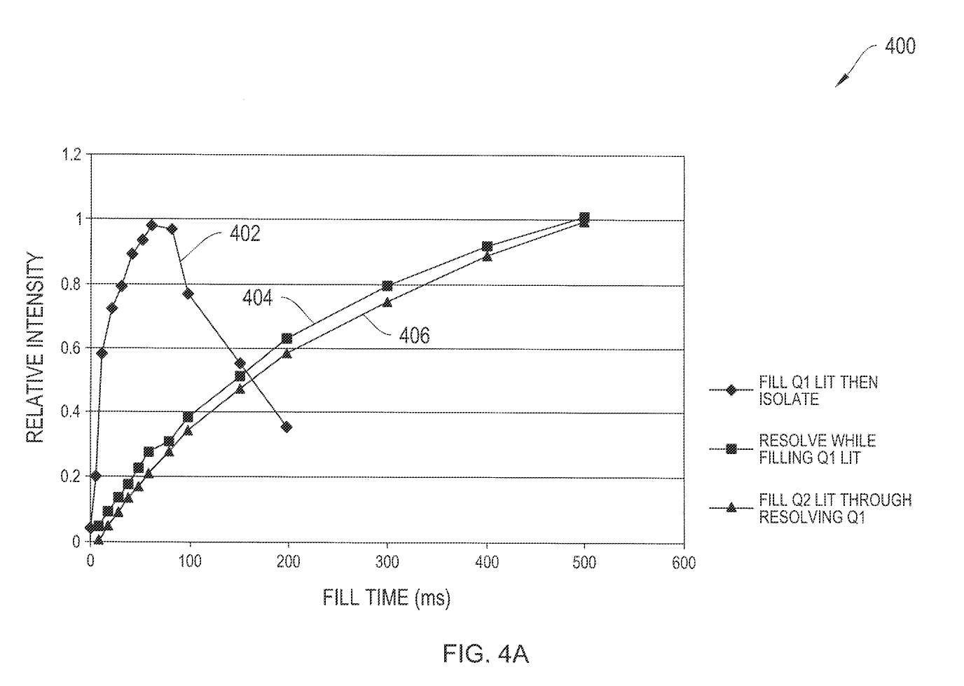

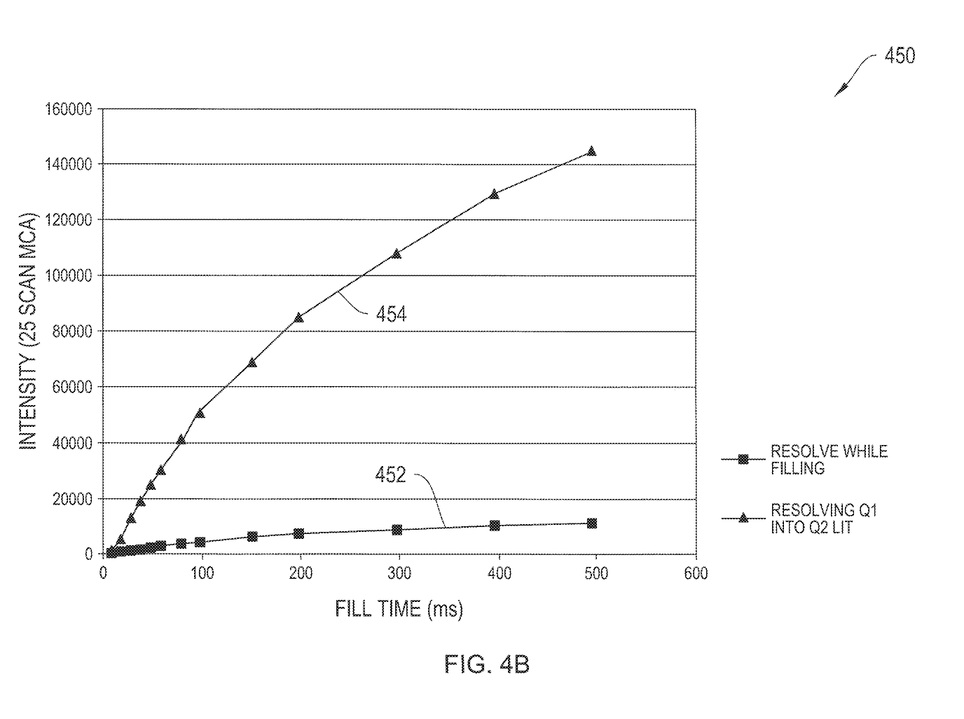

FIG. 4A is a graph 400 comparing space charge effects of various linear ion trap filling approaches according to an illustrative embodiment of the invention. In a first approach, represented by the plot 402, the Q1 linear ion trap is filled with ions generated by the ion source, then ions of interest are identified and isolated, while other ions are pumped out of the chamber. As illustrated in the graph 400, with the first approach, Q1 fills relatively rapidly, but the intensity of and sensitivity to the desired ions are greatly reduced as time passes due to space charge effects of the total ion population prior to any ion isolation. Space charge can occur when electric charge from charge carriers forms a continuum of charge in a region of space rather than each carrier acting as a distinct point-like charge. Space charge can impede the flow of ions in a mass analyzer by interfering with the electric field formed by a quadrupole rod set, which can be detrimental to the performance of the mass analyzer. In a second approach, represented by the plot 404 on the graph, the Q1 linear ion trap is filled while there are mass selecting voltages applied such that only ions of interest are trapped in Q1. In a third approach, represented by the plot 406 on the graph 400, Q1 is used as a mass filter to select ions for filling a chamber downstream of Q1 (e.g. Q2). This third approach, as illustrated by plot 406, can produce the superior analyzer performance in relation to intensity and sensitivity with respect to the first and second approaches.

FIG. 4B is another graph 450 comparing the space charge effects of linear ion trap filling approaches of plots 404 and 406 of FIG. 4A according to an illustrative embodiment of the invention. While the graph 400 shows relative intensities, graph 450 provides actual intensity levels which more clearly illustrate improved resolution and sensitivity. Plot 452 in graph 450 corresponds to plot 404 in graph 400, and plot 454 in graph 450 corresponds to plot 406 in graph 400. As clearly illustrated by the graph 450, the third approach to filling a linear ion trap (that is, using Q1 as a mass filter) greatly reduces space charge effects and allows the greatest intensity of and sensitivity to ions of interest.

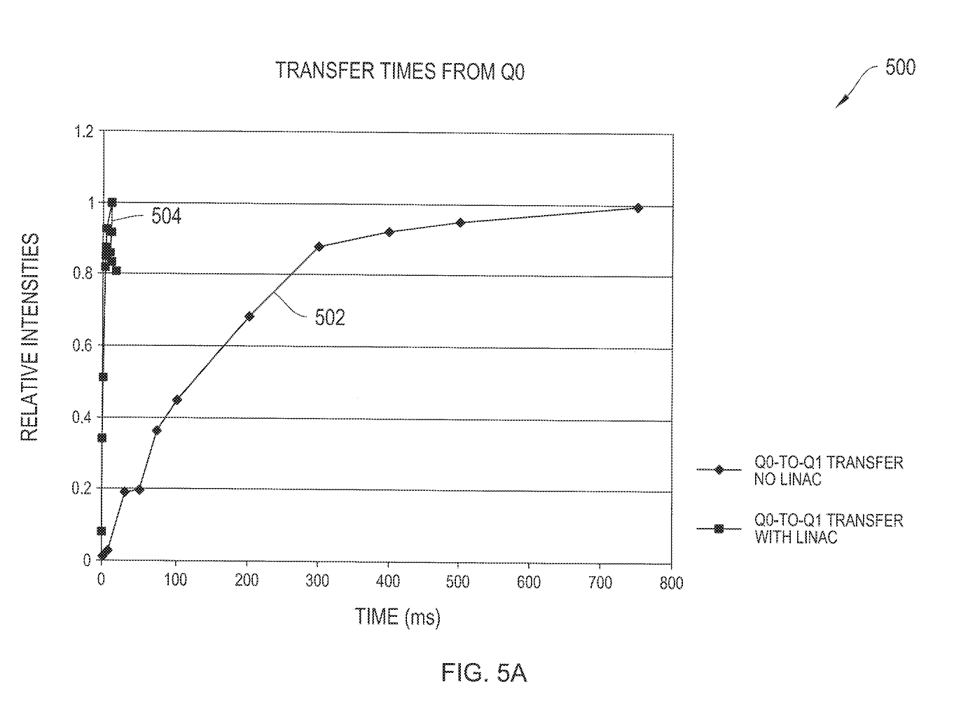

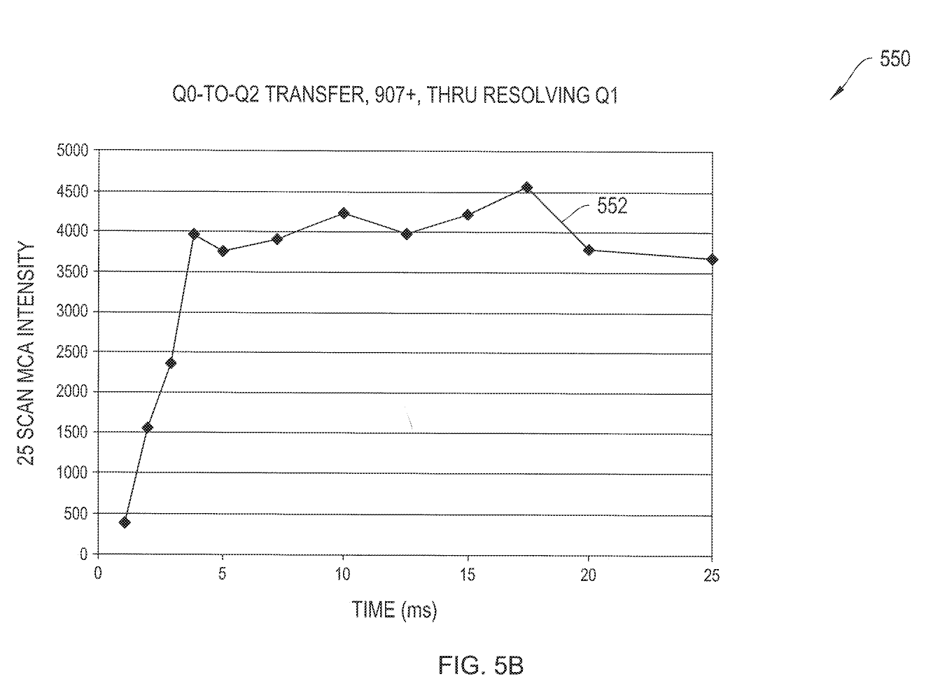

FIG. 5A is a graph 500 comparing transfer times out of a multi-mode ion controller using various ion transfer approaches according to an illustrative embodiment of the invention. In a first approach, represented by the plot 502, ions are transferred out of Q0 without the help of a linear particle accelerator (LINAC), as disclosed in U.S. Pat. No. 6,111,250, filed Aug. 29, 2000. In a second approach, represented by the plot 504, a LINAC is used to impose an axial field to help transfer ions out of Q0. As illustrated by the graph 500, ion transfer out of Q0 using a LINAC (i.e. the second approach) is much faster than ion transfer without a LINAC (i.e. the first approach). FIG. 5B is a graph 550 showing Q0-to-Q2 transfer time according to the second approach represented by plot 504 in graph 500. While the graph 500 shows relative intensities, graph 550 provides actual intensity levels which more clearly illustrate improved resolution and sensitivity. Plot 552 in graph 550 corresponds to plot 504 in graph 500. As illustrated by the graph 550, using a LINAC allows ion transfer to occur very quickly. Having a fast Q0-to-Q2 transfer time is desirable because it speeds up the cycle time of the mass spectrometer system.

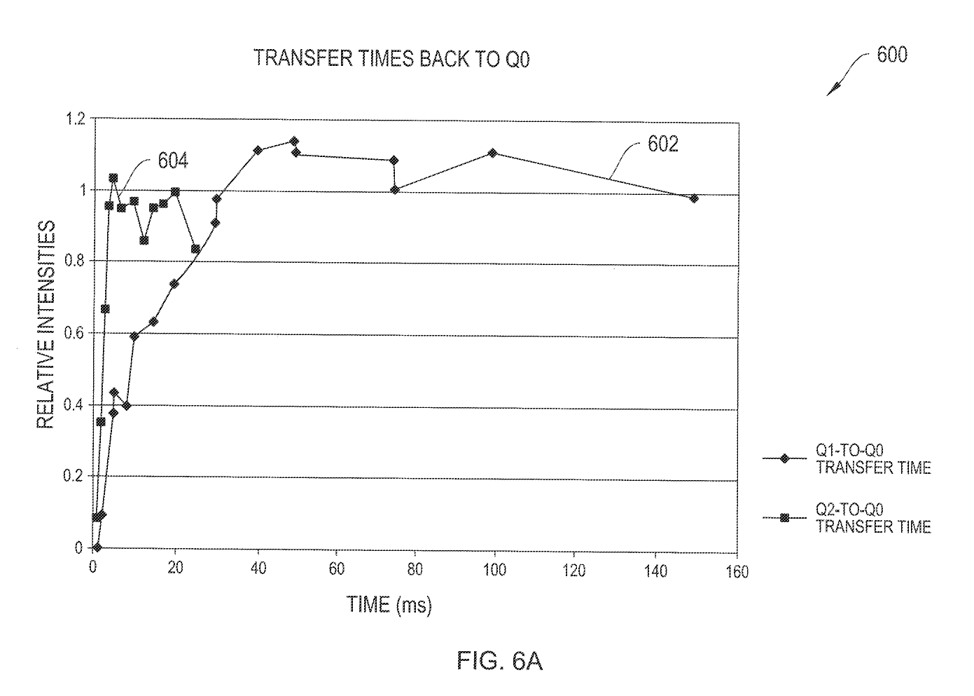

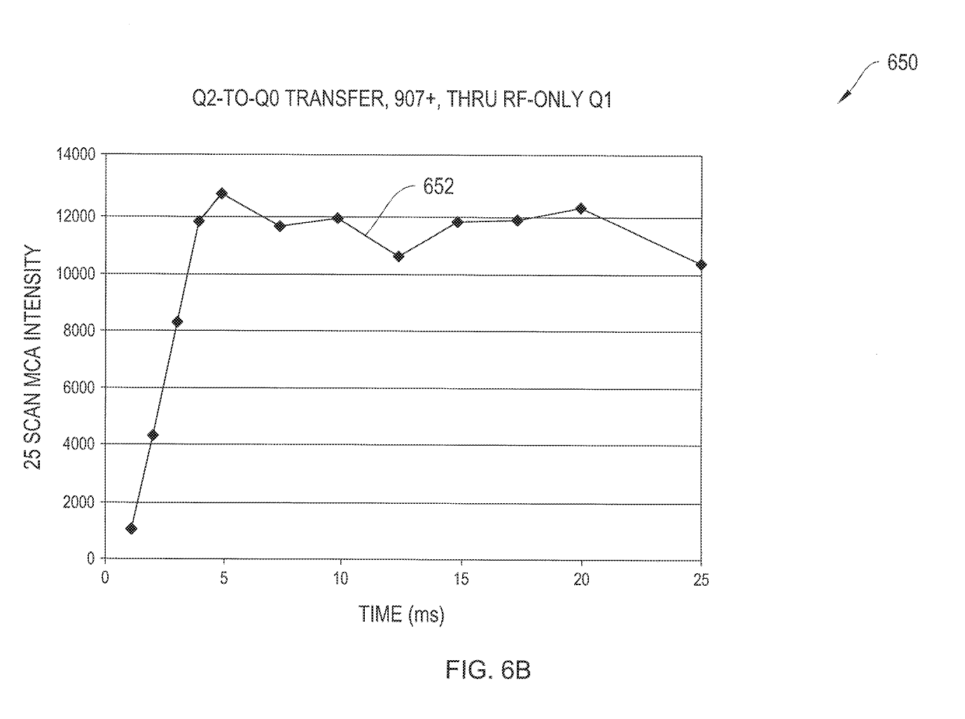

FIG. 6A is a graph 600 comparing transfer times back to Q0 according to various illustrative embodiments of the invention. In the first embodiment, the mass spectrometer has only two chambers, Q0 and Q1, so the ions in Q1 need to be cooled before the precursor ions can be isolated and moved back into Q0. This embodiment is represented by the plot 602 in graph 600. In the second embodiment, represented by the plot 604 in graph 600, the mass spectrometer has three chambers, Q0, Q1, and Q2. In this second embodiment, Q1 is used as a resolving chamber, and no cooling time is required in Q2 prior to moving the ions back into Q0. Q2 additionally is configured with LINAC electrodes to help speed up and facilitate the transfer from Q2 to Q0. As illustrated by the graph 600, using Q1 as a resolving chamber (i.e. the second embodiment) has a much faster transfer time back to Q0.

FIG. 6B is a graph 650 showing the Q2-to-Q0 transfer time according to an illustrative embodiment of the invention. While the graph 600 shows relative intensities, graph 650 provides actual intensity levels which more clearly illustrate improved resolution and sensitivity. Plot 652 in graph 650 corresponds to plot 604 in graph 600. As illustrated by the graph 650, using Q1 as a resolving chamber (e.g. the second illustrative embodiment) allows ion transfer from Q2 to Q0 to happen very quickly since no cooling time is required and because of the LINAC in Q2. Having a fast transfer time back into Q0 can be advantageous because a shorter back-to-Q0 time increases the duty cycle of a mass analyzer system and, thereby, increases analysis efficiency.

The efficiency of a mass analyzer system can be calculated as follows. First, the amount of time needed for one cycle of analysis is determined. The cycle time can include fill time (the time needed to move ions from the ion source through Q0), cooling time, time needed to fragment ions, time needed to select and isolate ions of interest, and overhead time. The fill time can then be divided by the cycle time. For example, in relation to the system and method described by FIGS. 2A and 2B, the fill time can be 10 ms, cooling time can be 25 ms, isolation time can be 1 ms, CID time can be 5 ms, resolving time can be 5 ms, and overhead time can be 5 ms, for a total cycle time of about 51 ms. The fill time, 10 ms, can be divided by the cycle time, 51 ms, for an efficiency of about 19.6%. In other illustrative embodiments, as described by FIGS. 3A and 3B, the fill time can be 10 ms, CID time can be 5 ms, resolving time can be 5 ms, and overhead time can be 5 ms, for a total cycle time of about 25 ms. Because a separate chamber is available for collecting ions of interest prior to fragmentation, no cooling or isolation time is needed. The fill time, 10 ms, can be divided by the cycle time, 25 ms, for an efficiency of about 40%.

FIG. 7A is a radial schematic view of the front end of an ion controller 700 with a linear particle accelerator (LINAC) according to an illustrative embodiment of the invention. The LINAC can have four electrodes 702, which are positioned between the rods of a quadrupole rod set 704. A variety of electrode shapes are possible, including electrodes with T-shaped cross-sections having stems 706. Other electrode shapes can include, without limitation, cylindrical and cup-shaped structures. In certain embodiments, substantially identical DC potentials are applied to the auxiliary LINAC electrodes 702, and depending on the shape of the auxiliary electrodes 702, an axial field toward the entrance or exit of a device, e.g., ion controller 700, is produced. In general, due to the shape of the auxiliary electrodes 702, no substantial DC potential difference may be required to generate an axial field. In some embodiments, one or more LINAC electrodes may be included in the systems 200 and/or 300 between quadrupole rod sets 208, 214, 310, 316, and/or 320. LINAC electrodes can increase the speed of ion transfer through Q0 and/or Q1 in systems 200 and/or 300 as well as through Q2 in system 300, decreasing the cycle time and improving the efficiency of a mass analyzer system such as system 200 and/or system 300. In some embodiments, LINAC electrodes may be controlled by a system controller, such as controllers 220 and/or 324 described with regard to FIGS. 2A and 3A to facilitate the transfer of ions among various elements of a mass analyzer system such as system 200 and/or system 300.

FIG. 7B is a radial schematic view of the back end of the ion controller 700 with a linear particle accelerator (LINAC) according to an illustrative embodiment of the invention. The auxiliary LINAC electrodes 702 can have stems with tapered profiles down the length of the rod array, resulting in shortened stems 710 as illustrated by the back end view. The amount or degree of tapering may vary.

While the applicant's teachings are described in conjunction with various embodiments, it is not intended that the applicant's teachings be limited to such embodiments. On the contrary, the applicant's teachings encompass various alternatives, modifications, and equivalents, as will be appreciated by those of skill in the art.

What is claimed is:

1. A mass analyzer system comprising:
an ion inlet for receiving a flow of ions,
a multi-mode ion controller for controlling some or all of the ions,
a multi-mode mass analyzer, in communication with the ion controller, for performing at least one of analyzing and controlling some or all of the ions,
a detector, in communication with the multi-mode mass analyzer, for detecting some or all of the ions, and
a processor for controlling the operation of at least one of the multi-mode ion controller and the multimode mass analyzer.

2. The system of claim 1, wherein the multi-mode ion controller is operable to function in a plurality of modes, the plurality of modes including an ion trap mode, a collision cell mode, and an ion guide mode.

3. The system of claim 2, wherein the multi-mode mass analyzer is operable to function in a plurality of modes including a mass selector mode and an ion controller mode.

4. The system of claim 3, wherein the mass selector mode enables the mass analyzer to function as at least one of a linear ion trap and a quadrupole mass spectrometer.

5. The system of claim 3, wherein the ion controller mode includes an ion trap mode, a collision cell mode, and an ion guide mode.

6. The system of claim 3, wherein the processor controls the direction of flow of the ions by controlling the operation of at least one of the multi-mode ion controller and the multi-mode mass analyzer.

7. The system of claim 6, wherein the processor sets a first mode of operation of at least one of the multi-mode ion controller and the multi-mode mass analyzer at a first instance.

8. The system of claim 7, wherein herein the processor sets a second mode of operation of at least one of the multi-mode ion controller and the multi-mode mass analyzer at a second instance.

9. The system of claim 8, wherein the processor controls the operation of the multi-mode ion controller and the multimode mass analyzer to:
pass ions through the multi-mode ion controller, the ion controller operating in an ion guide mode,
pass the ions into the multi-mode mass analyzer, operating in a mass selector mode, to select a first portion of ions,
pass the first portion of ions to the multi-mode ion controller, operating in a collision cell mode, to fragment the first portion of ions into a second portion of ions,
pass the second portion of ions to the multi-mode mass analyzer, operating in a mass selector mode, to select a third portion of ions, and
pass the third portion of ions to the detector for detection.

10. The system of claim 9 comprising passing some or all of the first portion of ions to the detector.

11. The system of claim 9, wherein the first portion of ions includes precursor ions.

12. The system of claim 9, wherein the second portion of ions includes daughter ions.

13. The system of claim 1, wherein the multi-mode ion controller includes at least one of a RF multi-pole and a RF ring guide.

14. The system of claim 1, wherein the processor includes a microcontroller.

15. A method for analyzing ions comprising:
receiving a flow of ions,
controlling some or all of the ions using a multi-mode ion controller,
performing at least one of analyzing and controlling some or all of the ions using a multi-mode mass analyzer in communication with the ion controller,
detecting some or all of the ions using a detector in communication with the multi-mode mass analyzer, and
controlling the operation of at least one of the multi-mode ion controller and the multimode mass analyzer using a processor.

16. The method of claim 15, wherein the processor controls the operation of the multi-mode ion controller and the multimode mass analyzer to:
pass ions through the multi-mode ion controller, the ion controller operating in an ion guide mode,
pass the ions into the multi-mode mass analyzer, operating in a mass selector mode, to select a first portion of ions,
pass the first portion of ions to the multi-mode ion controller, operating in a collision cell mode, to fragment the first portion of ions into a second portion of ions,
pass the second portion of ions to the multi-mode mass analyzer, operating in a mass selector mode, to select a third portion of ions, and
pass the third portion of ions to the detector for detection.

17. A mass analyzer system comprising:
an ion inlet for receiving a flow of ions,
a multi-mode ion controller for controlling some or all of the ions,
a multi-mode mass analyzer, in communication with the ion controller, for performing at least one of analyzing and controlling some or all of the ions,
an ion trap, in communication with the multi-mode mass analyzer, for trapping some or all of the ions,
a detector, in communication with the ion trap, for detecting some or all of the ions, and
a processor for controlling the operation of at least one of the multi-mode ion controller and the multimode mass analyzer.

18. The system of claim 17, wherein the multi-mode ion controller is operable to function in a plurality of modes, the plurality of modes including an ion trap mode, a collision cell mode, and an ion guide mode.

19. The system of claim 18, wherein the multi-mode mass analyzer is operable to function in a plurality of modes including a mass selector mode and an ion controller mode.

20. The system of claim 19, wherein the mass selector mode enables the mass analyzer to function as at least one of a linear ion trap, a quadrupole mass spectrometer, a time of flight mass spectrometer, and a Fourier transform mass analyzer (FTMS).

21. The system of claim 19, wherein the ion controller mode includes an ion trap mode, a collision cell mode, and an ion guide mode.

22. The system of claim 19, wherein the processor controls the direction of flow of the ions by controlling the operation of at least one of the multi-mode ion controller and the multi-mode mass analyzer.

23. The system of claim 22, wherein the processor sets a first mode of operation of at least one of the multi-mode ion controller and the multi-mode mass analyzer at a first instance.

24. The system of claim 23, wherein herein the processor sets a second mode of operation of at least one of the multi-mode ion controller and the multi-mode mass analyzer at a second instance.

25. The system of claim 24, wherein the processor controls the operation of the multi-mode ion controller and the multimode mass analyzer to:
pass ions through the multi-mode ion controller, the ion controller operating in an ion guide mode,
pass the ions through the multi-mode mass analyzer, operating in a mass selector mode, to select a first portion of ions,
pass the first portion of ions into the ion trap,
pass the first portion of ions through the multi-mode mass analyzer, operating in an ion guide mode,
pass the first portion of ions into the multi-mode ion controller, operating in a collision cell mode, to fragment the first portion of ions into a second portion of ions,
pass the second portion of ions to the multi-mode mass analyzer, operating in a mass selector mode, to select a third portion of ions, and
pass the third portion of ions to the detector for detection.

26. The system of claim 25 comprising passing some or all of the first portion of ions to the detector.

27. The system of claim 25, wherein the first portion of ions includes precursor ions.

28. The system of claim 25, wherein the second portion of ions includes daughter ions.

29. The system of claim 24, wherein the processor controls the operation of the multi-mode ion controller and the multimode mass analyzer to:
pass ions through the multi-mode ion controller, the ion controller operating in the ion guide mode,
pass the ions through the multi-mode mass analyzer, operating in the ion guide mode,
pass the ions into the ion trap,
pass the ions through the multi-mode mass analyzer, operating in the ion guide mode,
pass the ions into the multi-mode ion controller, operating in the collision cell mode, to fragment the ions into a first portion of ions,
pass the first portion of ions to the multi-mode mass analyzer, operating in a mass selector mode, to select a second portion of ions, and
pass the second portion of ions to the detector for detection.

30. The system of claim 17, wherein the multi-mode ion controller includes at least one of a RF multi-pole and a RF ring guide.

31. The system of claim 17, wherein the processor includes a microcontroller.

32. A method for analyzing ions comprising:
receiving a flow of ions,
controlling some or all of the ions using a multi-mode ion controller,
performing at least one of analyzing and controlling some or all of the ions using a multi-mode mass analyzer in communication with the ion controller,
trapping some or all of the ions using an ion trap in communication with the multi-mode mass analyzer,
detecting some or all of the ions using a detector in communication with the ion trap, and
controlling the operation of at least one of the multi-mode ion controller and the multimode mass analyzer using a processor.

33. The method of claim 32, wherein the processor controls the operation of the multi-mode ion controller and the multimode mass analyzer to:
pass ions through the multi-mode ion controller, the ion controller operating in the ion guide mode,
pass the ions through the multi-mode mass analyzer, operating in a mass selector mode, to select a first portion of ions,
pass the first portion of ions into the ion trap,
pass the first portion of ions through the multi-mode mass analyzer, operating in the ion guide mode,
pass the first portion of ions into the multi-mode ion controller, operating in the collision cell mode, to fragment the first portion of ions into a second portion of ions,
pass the second portion of ions to the multi-mode mass analyzer, operating in a mass selector mode, to select a third portion of ions, and
pass the third portion of ions to the detector for detection.

34. The method of claim 32, wherein the processor controls the operation of the multi-mode ion controller and the multimode mass analyzer to:
pass ions through the multi-mode ion controller, the ion controller operating in the ion guide mode,
pass the ions through the multi-mode mass analyzer, operating in the ion guide mode,
pass the ions into the ion trap,
pass the ions through the multi-mode mass analyzer, operating in the ion guide mode,
pass the ions into the multi-mode ion controller, operating in the collision cell mode, to fragment the ions into a first portion of ions,
pass the first portion of ions to the multi-mode mass analyzer, operating in a mass selector mode, to select a second portion of ions, and
pass the second portion of ions to the detector for detection.
